(19) United States
(12) Patent Application Publication
(10) Pub. No.: US 2021/0234971 A1
(43) Pub. Date: Jul. 29, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Kengo TOKUCHI, Kanagawa (JP); Toru HATORI, Kanagawa (JP)

(73) Assignee: FUJI XEROX CO., LTD., Tokyo (JP)

(21) Appl. No.: 16/936,640

(22) Filed: Jul. 23, 2020

(30) Foreign Application Priority Data
Jan. 28, 2020 (JP) 2020-011789

(51) Int. Cl. H04N 1/00; G06F 3/12

(52) U.S. Cl. CPC H04N 1/00145; H04N 1/00177; G06F 3/1287; G06F 3/1271; G06F 3/1205

(57) ABSTRACT

An information processing apparatus includes a processor configured to present a place that is a candidate for reservation and a service that is a candidate for use using a same application. The place and the service to be presented change in association with each other.

### CROSS-REFERENCE TO RELATED APPLICATIONS

This application is based on and claims priority under 35 USC 119 from Japanese Patent Application No. 2020-011789 filed Jan. 28, 2020.

### BACKGROUND

### (i) Technical Field

The present disclosure relates to an information processing apparatus and a non-transitory computer readable medium.

### (ii) Related Art

Systems for reserving places to be used are known.

In Japanese Unexamined Patent Application Publication No. 2004-178235, a system is described in which a user makes a tentative reservation at a time of a request to use a desired order or service, an approval condition and a reservation condition are determined by the passage of time, and approval and reservation are controlled on the basis of a result of the determination.

In Japanese Unexamined Patent Application Publication No. 2004-185580, a single system achieves plural reservation operations and use of plural reservation reception companies.

### SUMMARY

People who desire to reserve places might also desire to reserve services. The opposite is also possible.

Aspects of non-limiting embodiments of the present disclosure relate to provision of a mechanism for presenting places that are candidates for reservation and services that are candidates for use in association with each other.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to present a place that is a candidate for reservation and a service that is a candidate for use using a same application. The place and the service to be presented change in association with each other.

### BRIEF DESCRIPTION OF THE DRAWINGS

An exemplary embodiment of the present disclosure will be described in detail based on the following figures, wherein:

FIG. 1 is a block diagram illustrating the configuration of an information processing system according to an exemplary embodiment;

FIG. 2 is a block diagram illustrating the configuration of an operation management system;

FIG. 3 is a block diagram illustrating the configuration of a reservation management system;

FIG. 4 is a block diagram illustrating the configuration of a terminal apparatus;

FIG. 5 is a diagram illustrating a personal user management table;

FIG. 6 is a diagram illustrating a reservation management table;

FIG. 7 is a diagram illustrating a corporate user management table;

FIG. 8 is a diagram illustrating screen transitions;

FIG. 9 is a diagram illustrating a home screen;

FIG. 10 is a schematic diagram illustrating a relationship between booths and a shared office;

FIG. 11 is a diagram illustrating another home screen;

FIG. 12 is a diagram illustrating a screen;

FIG. 13 is a diagram illustrating another screen; and

FIG. 14 is a diagram illustrating another screen.

### DETAILED DESCRIPTION

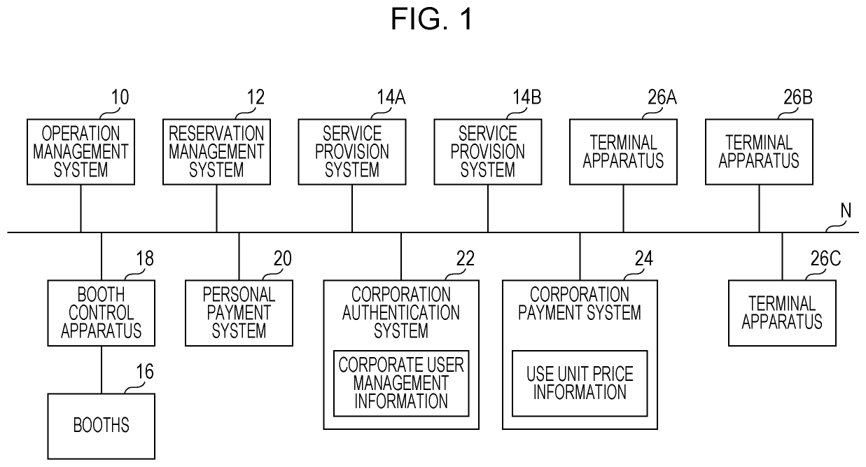

An information processing system according to an exemplary embodiment will be described with reference to FIG. 1. FIG. 1 illustrates an example of the configuration of the information processing system according to the present exemplary embodiment.

The information processing system according to the present exemplary embodiment includes an operation management system 10, a reservation management system 12, which is an example of a service provision system, service provision systems other than the reservation management system 12 (e.g., service provision systems 14A and 14B), a booth control apparatus 18 that controls booths 16, which are an example of use places, a personal payment system 20, a corporation authentication system 22, a corporation payment system 24, and terminal apparatuses (e.g., terminal apparatuses 26A to 26C). The number of systems and apparatuses illustrated in FIG. 1 is just an example.

The systems and the apparatuses included in the information processing system each have a function of communicating with the other systems and apparatuses. The communication may be achieved by wired communication employing cable or wireless communication. That is, the systems and the apparatuses may each be physically connected to the other systems and apparatuses and communicate information with each other or wirelessly communicate information. Short-distance wireless communication or Wi-Fi (registered trademark) may be used for the wireless communication. Another wireless communication standard may be used, instead. Short-distance wireless communication may be, for example, Bluetooth (registered trademark), radio-frequency identification (RFID), near-field communication (NFC), or the like. The systems and the apparatuses, for example, each communicate with the other systems and apparatuses through a communication path N such as local area network (LAN) or the Internet.

In the information processing system according to the present exemplary embodiment, the service provision systems provide services for users. The service provided by the service provision systems is, for example, a service for providing the booths 16 for users, a service for providing places other than the booths 16 (e.g., meeting rooms, shared rooms, shared offices, or other types of space), a service for providing printers, a service for providing virtual desktop infrastructure (VDI), a service for providing remote meetings, a web service, or another service. The web service is, for example, a service for providing applications on a network such as the Internet or another service. Examples of the web service include online learning (e.g., English conversation classes, etc.), web-based training (WBT), webmail, a social networking service (SNS), a service for providing moving images or music on the Internet, a service for selling products or making reservations on the Internet, a search service on the Internet, and a service for providing information on the Internet. It is needless to say that the service provision systems may provide other kinds of service.

When a user's account is created and the user is registered to the information processing system, for example, the user can use available services.

The user's account is, for example, a personal account for an individual person to use services or an organization account for a user belonging to an organization (e.g., a corporation such as a company or another organization) to use services. It is assumed in the following description, for example, that organizations are corporations (e.g., profit-making corporations, nonprofit corporations, etc.) and organization accounts are corporate accounts.

In the following description, users who use services with personal accounts will be referred to as “personal users”, and users who use services with corporate accounts will be referred to as “corporate users”.

Personal users can use services made available using personal accounts. For example, personal users are registered for each service and can use the services for which the personal users have been registered. Corporate users can use services made available using corporate accounts. When a contract to use one or more services is made between a corporation and a management company or the like that provides the operation management system 10, corporate users belonging to the corporation can use the one or more services made available by the contract.

A user might have both a personal account and a corporate account. When a user is registered as a personal user, for example, a personal account is assigned to the user. When the user also belongs to a corporation, a corporate account might be issued and assigned to the user. In this case, the user has both a personal account and a corporate account. The user may use a service using the personal account or the corporate account.

The services provided by the service provision systems are basically paid services, and when a user uses a service, a payment system makes payment for using the service. That is, when a service is used, a fee for using the service is charged, and the payment service performs a charging process (e.g., a payment process). It is needless to say that free services may also be provided, instead.

The operation management system 10 is configured to manage the operation of the information processing system according to the present exemplary embodiment. For example, the operation management system 10 helps the reservation management system 12 and the service provision systems 14A and 14B provide services and controls processes relating to payment. The operation management system 10 is managed, for example, by a management company or the like that provides the information processing system according to the present exemplary embodiment. Alternatively, information stored in the reservation management system 12 and the service provision systems 14A and 14B may be transmitted to and stored in the operation management system 10. Under control of the operation management system 10, the reservation management system 12 and the service provision systems 14A and 14B may communicate information with one another.

The reservation management system 12 is configured to manage reservations for the booths 16. If a user reserves one of the booths 16, for example, the user is permitted to use the reserved booth 16. If a user reserves one of the booths 16 while specifying a use period, in which the booth 16 is made available, for example, the user can use the reserved booth 16 for the use period. A use period is defined, for example, by a date and a time period. The reservation management system 12 may manage reservations for spaces or places other than the booths 16, instead.

The service provision systems 14A and 14B are configured to provide services other than service provided by the reservation management system 12. For example, the service provision systems 14A and 14B are configured to manage reservations for the services provided thereby. The service provision systems 14A and 14B may provide different services or the same services. Although the information processing system includes the service provision systems 14A and 14B as service provision systems other than the reservation management system 12 in the example illustrated in FIG. 1, it is only required that the information processing system include one or more service provision systems as systems other than the reservation management system 12.

The service provision systems (e.g., the reservation management system 12 and the service provision systems 14A and 14B) operate together under control of the operation management system 10 and share information managed thereby with one another. For example, the service provision systems share information indicating reservations for the services, information indicating places where the services are provided, information indicating use conditions of the services, information indicating use fees of the services, and other types of information with one another by communicating these pieces of information with one another. For example, the reservation management system 12 shares information indicating positions at which the booths 16, which are provided by the reservation management system 12, are installed with the service provision systems 14A and 14B. In addition, when a booth 16 is reserved, the reservation management system 12 shares information regarding the reservation (e.g., information for identifying the reserved booth 16, information indicating a time of the reservation, and information for identifying a user who has reserved the booth 16) with the service provision systems 14A and 14B. The same holds for the services provided by the service provision systems 14A and 14B.

The booths 16 are an example of spaces or places rented by users. Partitioned spaces, private rooms, seats, and sections are examples of the booths 16. The booths 16 rented by users are each provided with a controllable lock. For example, the booths 16 each include a door fitted with an electronic lock. The reservation management system 12 manages reservations for the booths 16.

A lighting device, a power supply, an air conditioner, and other apparatuses (e.g., a multifunction peripheral (MFP) having functions of printing, scanning, and copying) may also be provided in each of the booths 16.

Various sensors may be provided for each of the booths 16. For example, a human detection sensor that detects presence or absence of a person inside a booth 16, a temperature sensor that detects temperature inside a booth 16, a humidity sensor that detects humidity inside a booth 16, an odor sensor that detects odor inside a booth 16, an air pressure sensor that detects air pressure inside a booth 16, a camera that captures an image inside a booth 16, a microphone that collects sound inside a booth 16, and the like may be provided for each of the booths 16.

The booth control apparatus 18 controls the electronic locks provided for the booths 16 and various apparatuses provided inside the booths 16. For example, the booth control apparatus 18 includes a communication device, a user interface (UI), a memory, and a processor. The processor of the booth control apparatus 18, for example, controls the electronic locks and the various apparatuses in the booths 16. The booth control apparatus 18 may control only one booth 16 or plural booths 16. Alternatively, the information processing system may include plural booth control apparatuses 18, and each of the plural booth control apparatuses 18 may control one or more booths 16.

The personal payment system 20 is configured to, when a personal user uses a service using a personal account, make payment for the personal user. That is, the personal payment system 20 processes charging of use fees for personal users. The personal payment system 20 may be a known payment system. For example, a personal payment account, which is an account for making payment for a personal user, is created, and the personal account of the personal user and the personal payment account are associated with each other and managed. When a service is used using a personal account, the personal payment system 20 makes payment using a personal payment account associated with the personal account. Information regarding a credit card owned by the user is registered to the personal payment system 20, for example, and the personal payment system 20 makes payment using the credit card. The personal payment system 20 corresponds to an example of a first payment system.

The corporation authentication system 22 is configured to authenticate a user belonging to a corporation, which is an example of an organization. Sender policy framework (SPF), for example, is used for the authentication. For example, the corporation authentication system 22 stores corporate user management information. Cooperation identification information (e.g., a corporation identifier (ID)) for identifying a corporation and user information regarding users belonging to the corporation (e.g., information including user identification information for identifying users), for example, are registered in corporate user management information and managed for each corporation while being associated with each other.

The corporation payment system 24 is configured to, when a user uses a service using a corporate account, make payment for a corporation having the corporate account. That is, the corporation payment system 24 processes charging of use fees for corporations. The corporation payment system 24 may be a known payment system. For example, use unit price information indicating a unit price of use of a service is created and stored in the corporation payment system 24. The unit price of use may be determined for each corporation. The unit price of use is determined, for example, by a contract. The corporation payment system 24 makes payment for corporations using use unit price information.

The terminal apparatuses 26A to 26C are, for example, personal computers (PCs), tablet PCs, smartphones, or mobile phones.

For example, the terminal apparatus 26A is used by a personal user, the terminal apparatus 26B is used by a user belonging to a corporation, and the terminal apparatus 26C is used by a user who manages users belonging to corporations. The terminal apparatus 26A to 26C will be referred to as “terminal apparatuses 26” hereinafter when the terminal apparatuses 26A to 26C need not be distinguished from one another. A terminal apparatus used by a person who manages the operation management system 10 may also be included in the information processing system.

In the information processing system according to the present exemplary embodiment, data regarding records of use of services by users is transmitted to different payment systems in accordance with types of account of the users, and the payment systems make payments. Records of use include, for example, types of service, the length of use periods of services, use periods, and the number of times of use. The payment systems make payment on the basis of the records of use. For example, data regarding records of use is transmitted to the payment systems at predetermined time intervals (e.g., every fiscal month), and the payment systems make payment.

More specifically, when a user uses a service using a personal account, data regarding records of use of the service by the user is transmitted to the personal payment system 20, and the personal payment system 20 makes payment for the user.

When users belonging to a certain corporation use services using corporate accounts, data regarding records of use of the services by the users is transmitted to the corporation payment system 24, and the corporation payment system 24 makes payment for the corporation. The corporation payment system 24 does not make payment for individual users belonging to corporations.

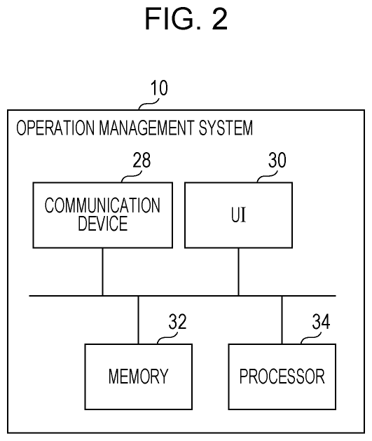

The configuration of the operation management system 10 will be described in detail hereinafter with reference to FIG. 2. FIG. 2 illustrates an example of the configuration of the operation management system 10.

The operation management system 10 includes, for example, a communication device 28, a UI 30, a memory 32, and a processor 34. The operation management system 10 may also include other components.

The communication device 28 is a communication interface and has a function of transmitting data to other apparatuses and a function of receiving data from other apparatuses. The communication device 28 may have a wireless communication function or a wired communication function. For example, the communication device 28 may communicate with other apparatuses through short-distance wireless communication or through the communication path N such as a LAN or the Internet.

The UI 30 includes at least a display device or an operation device. The display device is a liquid crystal display or an electroluminescent (EL) display, or the like. The operation device is a keyboard, input keys, an operation panel, or the like. The UI 30 may be a touch panel that serves as both a display device and an operation device, instead.

The memory 32 achieves one or more storage areas for storing data. The memory 32 is, for example, a hard disk drive, one of various memories (e.g., a random-access memory (RAM), a dynamic RAM (DRAM), or a read-only memory (ROM)), another storage device (e.g., an optical disc), or any selective combination of these. The operation management system 10 includes one or more memories 32.

The processor 34 is configured to control the operation of each component of the operation management system 10. The processor 34 may include a memory.

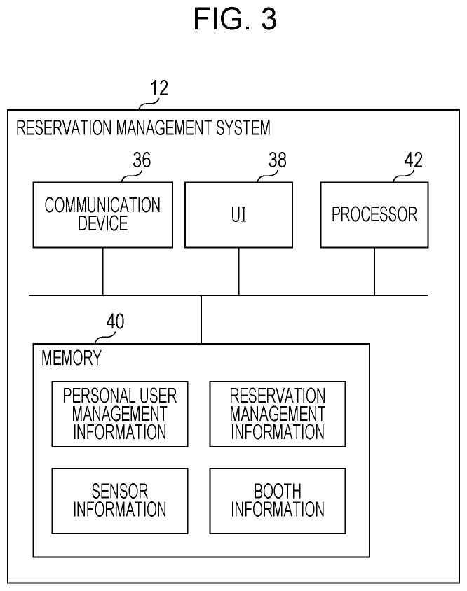

The configuration of the reservation management system 12 will be described in detail hereinafter with reference to FIG. 3. FIG. 3 illustrates an example of the configuration of the reservation management system 12.

The reservation management system 12 includes, for example, a communication device 36, a UI 38, a memory 40, and a processor 42. The reservation management system 12 may also include other components.

The communication device 36 is a communication interface and has a function of transmitting data to other apparatuses and a function of receiving data from other apparatuses. The communication device 36 may have a wireless communication function or a wired communication function. For example, the communication device 36 may communicate with other apparatuses through short-distance wireless communication or through the communication path N such as a LAN or the Internet.

The UI 38 includes at least a display device or an operation device. The display device is a liquid crystal display, an EL display, or the like. The operation device is a keyboard, input keys, an operation panel, or the like. The UI 38 may be a touch panel that serves as both a display device and an operation device, instead.

The memory 40 achieves one or more storage areas for storing data. The memory 40 is, for example, a hard disk drive, one of various memories (e.g., a RAM, a DRAM, or a ROM), another storage device (e.g., an optical disc), or any selective combination of these. The operation management system 10 includes one or more memories 40.

The memory 40 stores, for example, personal user management information, reservation management information, sensor information, and booth information.

The personal user management information is used to manage users registered in the reservation management system 12. For example, accounts of the users registered in the reservation management system 12 are registered in the personal user management information. More specifically, user information and the like regarding the users registered in the reservation management system 12 are registered in the personal user management information. The users registered in the reservation management system 12 can use the service provided by the reservation management system 12. In addition, the users registered in the reservation management system 12 can reserve the booths 16 using the reservation management system 12.

The reservation management information is used to manage reservations for the booths 16. For example, booth identification information for identifying the booth 16, use period information indicating use periods (e.g., times of reservations) of the booth 16, user information regarding users who have reserved the booths 16, and use information necessary to use the booth 16 in use periods are registered in the reservation management information.

The sensor information is obtained by the sensors provided for the booth 16. If one of the sensors detects an abnormality, information indicating the detection of the abnormality may be included in the sensor information. For example, sensor information regarding each of the booths 16 is stored in the memory 40.

The booth information indicates use conditions of the booths 16 and the like. For example, whether the booths 16 are being used is managed, and information regarding these use conditions is included in the booth information.

The personal user management information, the reservation management information, the sensor information, and the booth information are transmitted to and shared by the service provision systems 14A and 14B.

At least the personal user management information, the reservation management information, the sensor information, or the booth information may be stored in the memory 32 of the operation management system 10. In this case, the information stored in the operation management system 10 need not be stored in the reservation management system 12.

The processor 42 is configured to control the operation of each component of the reservation management system 12. The processor 42 may include a memory.

For example, the processor 42 is configured to manage reservations for the booths 16. The processor 42 receives requests to reserve the booths 16 from the terminal apparatuses 26, for example, and registers the reservations for the booths 16 to the reservation management information. The processor 42 permits the users who have reserved the booths 16 to use the corresponding booths 16. If use periods are determined, the processor 42 permits the users to use the corresponding booths 16 for the use periods.

The processor 42 is also configured to transmit data regarding records of use, by users, of service provided by the reservation management system 12 (e.g., data regarding records of use of the booths 16) to different payment systems in accordance with types of account of the users. For example, when a service (e.g., one of the booths 16) provided by the reservation management system 12 is used using a personal account, for example, the processor 42 transmits data regarding a record of the use to the personal payment system 20. When a service (e.g., one of the booths 16) provided by the reservation management system 12 is used using a corporate account, the processor 42 transmits data regarding a record of the use to the corporation payment system 24. As a result, when a service is used using a personal account, the personal payment system 20 makes payment, and when a service is used using a corporate account, the corporation payment system 24 makes payment.

The processor 42 may also be configured to create accounts for using the service provided by the reservation management system 12, register users, and authenticate users.

The processes performed by the processor 42 of the reservation management system 12 may be performed by the processor 34 of the operation management system 10, instead. When a service is used using a corporate account, for example, the processor 34 of the operation management system 10 may transmit data regarding a record of the use to the corporation payment system 24. Similarly, the processor 34 of the operation management system 10 may perform other processes, instead.

The service provision systems 14A and 14B each include, as with the reservation management system 12, a communication device, a UI, a memory, and a processor.

The memory of the service provision system 14A stores personal user management information used to manage users registered in the service provision system 14A. For example, accounts of the users registered in the service provision system 14A are registered in the personal user management information. The users registered in the service provision system 14A can use service provided by the service provision system 14A. The same holds for the service provision system 14B.

When the service provided by the service provision system 14A is reservable, the memory of the service provision system 14A stores reservation management information for managing reservations for the service provided by the service provision system 14A. The same holds for the service provision system 14B.

The memory of the service provision system 14A also stores information indicating a use condition of the service provided thereby and the like. The same holds for the service provision system 14B.

The information (e.g., the personal user management information, the reservation management information, and the information indicating the use condition) stored in the service provision system 14A is transmitted to and shared by the reservation management system 12 and the service provision system 14B. The same holds for information stored in the service provision system 14B.

The processor of the service provision system 14A is configured to transmit data regarding records of use, by users, of the service provided by the service provision system 14A to different payment systems in accordance with types of account of the users. For example, when a service provided by the service provision system 14A is used using a personal account, the processor 42 of the service provision system 14A transmits data regarding a record of the use to the personal payment system 20. When a service provided by the service provision system 14A is used using a corporate account, the processor 42 of the service provision system 14A transmits data regarding a record of the use to the corporation payment system 24. As a result, when a service is used using a personal account, the personal payment system 20 makes payment, and when a service used using a corporate account, the corporation payment system 24 makes payment. The same holds for the service provision system 14B.

The processor of the service provision system 14A may also be configured to create accounts for using the service provided by the service provision system 14A, register users, and authenticate users. The same holds for the service provision system 14B.

The processes performed by the processors of the service provision systems 14A and 14B may be performed by the processor 34 of the operation management system 10, instead.

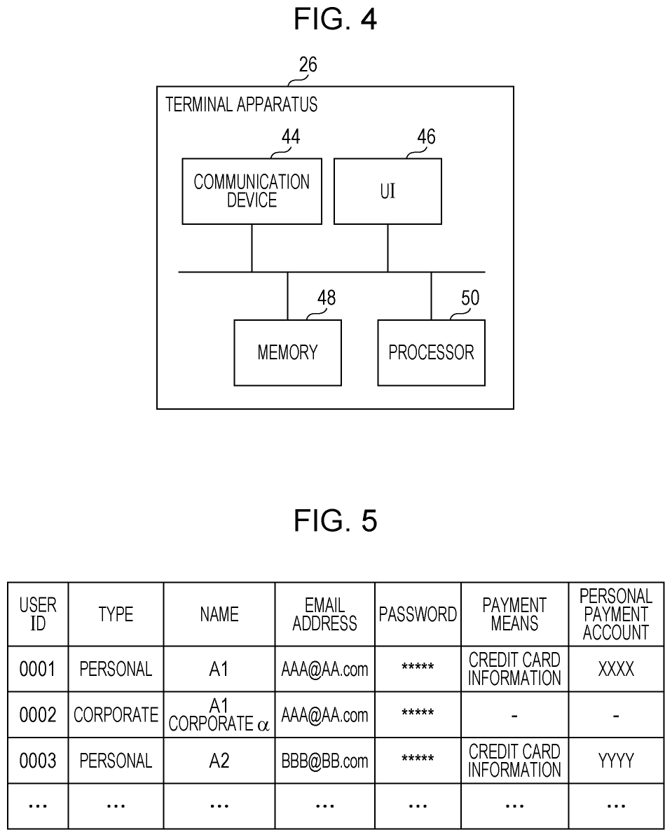

The configuration of each of the terminal apparatuses 26 will be described in detail hereinafter with reference to FIG. 4. FIG. 4 illustrates an example of the configuration of each of the terminal apparatuses 26.

The terminal apparatus 26 includes, for example, a communication device 44, a UI 46, a memory 48, and a processor 50.

The communication device 44 is a communication interface and has a function of transmitting data to other apparatuses and a function of receiving data from other apparatuses. The communication device 44 may have a wireless communication function or a wired communication function. For example, the communication device 44 may communicate with other apparatuses through short-distance wireless communication or through the communication path N such as a LAN or the Internet.

The UI 46 includes at least a display device or an operation device. The display device is a liquid crystal display or an EL display. The operation device is a keyboard, input keys, an operation panel, or the like. The UI 46 may be a touch panel that serves as both a display device and an operation device, instead.

The memory 48 achieves one or more storage areas for storing data. The memory 48 is, for example, a hard disk drive, one of various memories (e.g., a RAM, a DRAM, or a ROM), another storage device (e.g., an optical disc), or any selective combination of these. The terminal apparatus 26 includes one or more memories 48.

The processor 50 is configured to control the operation of each component of the terminal apparatus 26. The processor 50 may include a memory.

In addition, the processor 50 presents places that are candidates for reservation and services that are candidates for use using the same application. The places and the services to be presented change in association with each other. That is, if the places to be presented change, the processor 50 presents different services. The places are, for example, the booths 16. It is needless to say that places other than the booths 16 may be presented as candidates for reservation. It is assumed in the following description that the booths 16 are presented as an example of the places. The application is, for example, a program stored in the memory 48 of the terminal apparatus 26. For example, the processor 50 executes the application to display, on the UI 46 of the terminal apparatus 26, a screen for presenting the booths 16 and services other than the booths 16. The application for presenting places and services will be referred to as a “presentation application” hereinafter. Services other than the booths 16 presented by the application that presents the booths 16 will be referred to as “cooperative services”.

For example, the processor 50 executes the presentation application to communicate with the reservation management system 12, receive information regarding the booths 16 presented by the reservation management system 12, and cause a screen including a list of the booth 16 on the UI 46 of the terminal apparatus 26. The processor 50 also receives information regarding services provided by another service provision system from the other service provision system through or not through the reservation management system 12 and displays the information in the screen for reserving the booths 16. The information regarding the services displayed on the screen is information regarding cooperative services. For example, the processor 50 may receive information regarding cooperative services provided by other service provision systems in which the user is registered and display the information on a screen, or receive information regarding cooperative services provided by other service provision systems and display the information on a screen regardless of whether the user is registered in the other service provision systems. When the user needs to log in to the reservation management system 12, a screen including a list of the booths 16 is displayed on the UI 46 after the user logs in to the reservation management system 12. Similarly, when the user needs to log in to another service provision system, information regarding services may be displayed on a screen after the user logs in to the other service provision system. The user may log in to the reservation management system 12 and the service provision systems 14A and 14B separately or through single sign-on. That is, the user may log in to the reservation management system 12 and the service provision systems 14A and 14B separately by inputting corresponding user IDs and passwords to the reservation management system 12 and the service provision systems 14A and 14B. In another example, the user may simultaneously log in to the reservation management system 12 and the service provision systems 14A and 14B by inputting a common user ID and a common password. Alternatively, the user may be permitted to log in to the reservation management system 12 and the service provision systems 14A and 14B by logging in to the operation management system 10. The presentation application may be a web browser. In this case, the screen for presenting the booths 16 and services is a screen displayed on the website.

The booths 16 and the cooperative services may be presented by the operation management system 10, the reservation management system 12, or another service provision system, instead. For example, the processor 42 of the reservation management system 12 transmits information regarding the screen including the list of the booths 16 to the terminal apparatus 26 to display the screen on the UI 46 of the terminal apparatus 26. In addition, the processor 42 receives information regarding the cooperative services from the service provision systems 14A and 14B and transmits the information to the terminal apparatus 26 to display the information on the UI 46. At this time, the processor 42 presents the booths 16 and the cooperative services using the same application. For example, the processor 42 displays the information regarding the cooperative services in the screen including the list of the booths 16. This process may be performed by the processor 34 of the operation management system 10 or the processor of the service provision system 14A or 14B, instead. In the following exemplary embodiment, examples, and modifications, too, the presentation process may be performed by the terminal apparatus 26, the operation management system 10, the reservation management system 12, or another service provision system.

The processor 50 may change booths 16 and cooperative services to be presented in accordance with a relationship between booths 16 that are candidates for reservation and places where cooperative services that are candidates for use are provided. For example, the processor 50 changes the booths 16 and the cooperative services to be presented in accordance with a relationship of places (i.e., a positional relationship). For example, the processor 50 presents, for each booth 16, services provided at places within a predetermined distance from a place where the booth 16 is installed while associating the services with the booth 16 as cooperative services. Information indicating the place where each booth 16 is installed is stored in the reservation management system 12 or the operation management system 10 in advance, and information indicating places where services other than the booths 16 are provided is stored in a service provision system that provides the services or the operation management system 10 in advance. The processor 50 presents, for each booth 16, services provided at places within the predetermined distance from the place where the booth 16 is installed on the basis of these pieces of information while associating the services with the booth 16 as cooperative services.

The processor 50 of the terminal apparatus 26 may change the cooperative services to be presented in accordance with a relationship between currently available booths 16 and places where the cooperative services are provided. The currently available booths 16 are, for example, currently reservable booths 16. For example, the processor 50 receives information regarding currently available booths 16 from the reservation management system 12 and displays a screen including a list of the currently available booths 16 on the UI 46 of the terminal apparatus 26. The processor 50 also receives, from the service provision systems 14A and 14B for each of the currently available booths 16, information regarding services provided at places within the predetermined distance from a place where the booth 16 is installed and displays the information on the screen while associating the information with the booth 16 as information regarding cooperative services.

The processor 50 of the terminal apparatus 26 may change the cooperative services to be presented in accordance with a relationship between currently available booths 16 located within a predetermined range from a position of the user and the places where the cooperative services are provided. The position of the user is a position of the terminal apparatus 26 used by the user. The position of the terminal apparatus 26 is obtained, for example, using a global positioning system (GPS). For example, the processor 50 receives, from the reservation management system 12, currently available booths 16 installed at places within the predetermined distance from the position of the user and displays a screen including a list of the booths 16 on the UI 46 of the terminal apparatus 26. The processor 50 also receives, from the service provision systems 14A and 14B for each of the currently available booths 16, information regarding services provided at places within the predetermined distance from the place where the booth 16 is installed and displays the information on the screen while associating the information with the booth 16 as information regarding cooperative services.

In the information processing system according to the present exemplary embodiment, an account for using the services (e.g., the booths 16 and the cooperative services) may be created through a different process in accordance with a type of user.

When payment means to be used by a personal user is registered to the personal payment system 20, for example, the processor 42 of the reservation management system 12 creates a personal account for making the booths 16 available to the personal user. When a user belonging to a corporation receives a notification about user registration and information regarding the user is registered, on the other hand, the processor 42 creates a corporate account for enabling the user to use the booths 16. Personal accounts or corporate accounts for enabling the user to the services provided by the service provision systems 14A and 14B are also created in the same manner. This process may be performed by the processor 34 of the operation management system 10, instead.

Now, a process for registering a personal user to the reservation management system 12 will be described. A case where a personal user is registered to the reservation management system 12 is an example of a case where a personal user makes a contract to use the service provided by the reservation management system 12.

First, the processor 42 of the reservation management system 12 receives a request to register a personal user and registers the personal user to the reservation management system 12. For example, a user accesses the reservation management system 12 using the terminal apparatus 26A and requests the reservation management system 12 to register a personal user. As a result, the UI 46 of the terminal apparatus 26A displays a screen for registering the user to the reservation management system 12 as a personal user. The user inputs information such as a name thereof, an email address thereof, and a password on the screen using the terminal apparatus 26A, and the terminal apparatus 26A transmits the information to the reservation management system 12. The processor 42 of the reservation management system 12 registers the information to the personal user management information, creates a personal account, and issues the personal account to the user. For example, the processor 42 creates a user ID associated with the personal account, registers the user ID to the personal user management information, and transmits the user ID to the terminal apparatus 26A. As a result, the user is notified of the user ID. Alternatively, the user ID may be determined by the user, input to the reservation management system 12, and registered to the personal user management information. The user ID and the password associated with the personal account are used by the user to log in to the reservation management system 12 using the personal account.

When payment means has not been registered, the user can log in to the reservation management system 12 using the personal account but is not enabled to reserve the booths 16. That is, the processor 42 of the reservation management system 12 does not permit the user to reserve the booths 16.

Next, the processor 42 of the reservation management system 12 registers payment means for using the booths 16 to the reservation management system 12 and the personal payment system 20. When the user is registered to the reservation management system 12 and a personal account is created, for example, a screen for registering payment means or a menu for displaying the screen is displayed on the UI 46 of the terminal apparatus 26A. The user inputs information regarding payment means on the screen using the terminal apparatus 26A. When a credit card is used as the payment means, for example, the user inputs information regarding the credit card (e.g., a name of an owner of the credit card, a number, an expiration date, and a security code). The information regarding the credit card is an example of information regarding payment means. The information regarding the credit card is transmitted from the terminal apparatus 26A to the reservation management system 12. The processor 42 of the reservation management system 12 registers the information regarding the credit card to the personal user registration information while associating the information with the personal account. The information regarding the credit card is also transmitted to the personal payment system 20 and registered to the personal payment system 20.

Upon registering the information regarding the credit card, the personal payment system 20 creates a personal payment account.

Information regarding the personal payment account is transmitted from the personal payment system 20 to the reservation management system 12. The processor 42 of the reservation management system 12 registers the personal account and the personal payment account to the personal user management information while associating the personal account and the personal payment account with each other.

After the information regarding the credit card is registered to the personal payment system 20, the personal user can reserve the booths 16. That is, the processor 42 of the reservation management system 12 permits the personal user to reserve the booths 16.

Names of personal users, email addresses, passwords, and information regarding credit cards may be stored in and managed by the operation management system 10, instead.

The personal user management information will be described in detail hereinafter with reference to FIG. 5. FIG. 5 illustrates an example of a personal user management table, which is an example of the personal user management information. Data on the personal user management table is stored in the memory 40 of the reservation management system 12.

On the personal user management table, for example, a user ID, information indicating a type of user, information indicating a name of a user, information indicating an email address of a user, a password, information indicating payment means, and a personal payment account are associated with one another for each user.

A type of user is a personal user or a corporate user.

As described above, a personal user is requested to input information regarding a credit card, which is an example of payment means, and the input information regarding a credit card is registered in the personal user management table as information indicating payment means.

In addition, a personal payment account for making payment with the personal payment system 20 is created for a personal user and registered in the personal user management table.

As described later, a user registered as a corporate user is not requested to input information regarding a credit card, which is an example of payment means, and information regarding a credit card is not registered in the personal user management table for a user registered as a corporate user. In addition, a personal payment account is not created, and a personal payment account is not associated with a corporate user.

For example, accounts including user IDs “0001” and “0003” are personal accounts, and a user A1 corresponding to the user ID “0001” and a user A2 corresponding to the user ID “0003” are registered in the personal user management table as personal users.

As described later, accounts of individual users belonging to corporations are registered to the personal user management table as corporate accounts. For example, the user A1 is also registered in the personal user management table as a user belonging to a corporate a. An account including an user ID “0002” is a corporate account associated with the user A1. Creation and registration of a corporate account will be described in detail later. The same email address may be registered for a personal account and a corporate account of a single user, or registration of the same mail address may be inhibited.

Personal user management tables are also created for the service provision systems 14A and 14B and stored in the service provision systems 14A and 14B, respectively. For example, information regarding the user is registered to the personal user management information stored in the display device 14, and the user is registered to the service provision system 14A. The same holds for the service provision system 14B.

The user may log in to the service provision systems through single sign-on or may separately log in to the service provision systems. When the user logs in to the operation management system 10 through single sign-on, for example, the user may be permitted to log in to the service provision systems. In this case, a single user ID and a single password are used for the service provision systems.

Data on the personal user management tables may be stored in the memory 32 of the operation management system 10, and the operation management system 10 may manage information registered in the personal user management tables.

As described above, after a personal account and a personal payment account are created for a personal user and registered to the personal user management table, the personal user can reserve the booths 16. The same holds for the services other than the booths 16.

When a personal user accesses the reservation management system 12 using the terminal apparatus 26A, for example, a login screen is displayed on the UI 46 of the terminal apparatus 26A. The login screen includes a field for inputting information (e.g., a user ID and a password) for logging in to the reservation management system 12 using a personal account. When the user inputs a user ID and a password on the login screen, the terminal apparatus 26A transmits the input user ID and password to the reservation management system 12. If the input user ID and password are registered in the personal user management table, the processor 42 of the reservation management system 12 permits the user to log in. If the input user ID and password are not registered in the personal user management table, the processor 42 of the reservation management system 12 does not permit the user to log in.

If login to the reservation management system 12 is permitted, the UI 46 of the terminal apparatus 26A displays a reservation screen. The reservation screen is a screen for reserving the booths 16. The user can find places where the booths 16 are installed, reservable booths 16, and reservable use periods on the reservation screen. A list of the reservable booths 16 or a list of the reservable use periods may also be displayed. The user reserves one of the booths 16 by specifying the booth 16 and a use period, and the terminal apparatus 26A transmits information indicating the specified booth 16 and use period to the reservation management system 12. The processor 42 of the reservation management system 12 registers the booth 16 and the use period specified by the user to the reservation management information. The reservation of a booth 16 is thus completed.

The processor 42 of the reservation management system 12 also creates use information, which is necessary to use the booth 16 in the use period, registers the use information to the reservation management information while associating the use information with the reserved booth 16 and use period, and transmits the use information to the terminal apparatus 26A, which has been used for the reservation. The use information may be displayed on the UI 46 of the terminal apparatus 26A or stored in the memory 48 of the terminal apparatus 26A. The use information is, for example, information including a password and key information. For example, the processor 42 of the reservation management system 12 creates different use information for different reservations. The user who uses the terminal apparatus 26A can use the booths 16 using the use information. When a booth 16 is locked, for example, use information is used to unlock the booth 16. In addition, use information may be used to indicate that a booth 16 is being legitimately used. When the booths 16 are seats or vehicles, for example, use information may be used to indicate that the seats or the vehicles are being legitimately used. When the booths 16 are open spaces or places, or when no operation is necessary to use the booths 16, use information need not be used.

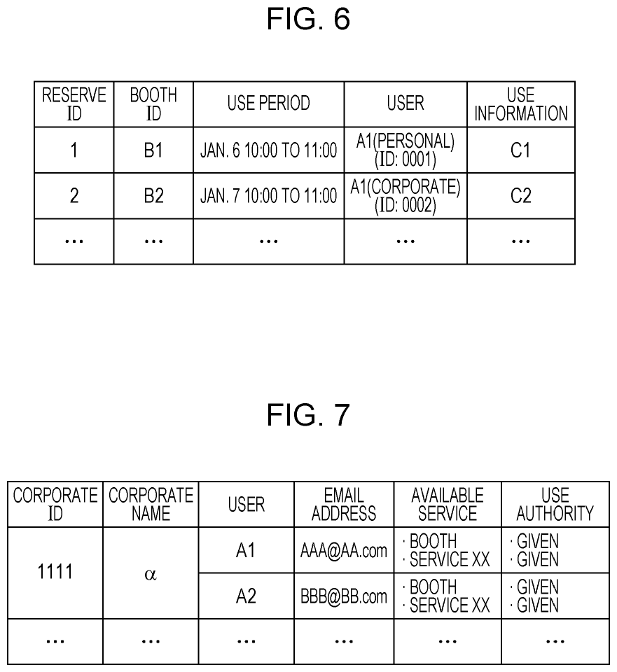

The reservation management information will be described in detail hereinafter with reference to FIG. 6. FIG. 6 illustrates an example of a reservation management table, which is an example of the reservation management information. Data on the reservation management table is stored in the memory 40 of the reservation management system 12.

On the reservation management table, for example, a reservation ID, a booth ID, information indicating a use period, information regarding a user, and use information are associated with one another for each reservation for a booth 16.

A booth ID is an example of information for identifying a reserved booth 16. A booth ID is determined for each booth 16 and associated with the booth 16 in advance.

A use period is a period in which a reserved booth 16 is used. A use period is specified, for example, when a user reserves a booth 16.

Information regarding a user includes user identification information for identifying a user who has reserved a booth 16 and terminal identification information for identifying a terminal apparatus 26 used by a user. User identification information includes, for example, information indicating a name of a user, a user ID, information indicating a type of account of a user, and an email address. Terminal identification information is, for example, address information (e.g., an Internet protocol (IP) address or a media access control (MAC) address) regarding a terminal apparatus 26, a serial number of a terminal apparatus 26, or the like. For example, when a user reserves a booth 16, information regarding the user is transmitted from a terminal apparatus 26 used for the reservation to the reservation management system 12 and registered to the reservation management table.

The reservation management table will be described with reference to a specific example. The user A1 having the personal account including the user ID “0001” has reserved a booth 16 corresponding to a booth ID “B1”. A use period is 10:00 to 11:00 on January 6. Use information C1 is defined as information for using the booth 16 on January 6 from 10:00 to 11:00. The use information C1 is transmitted from the reservation management system 12 to a terminal apparatus 26 used for the reservation.

The user A1 is also registered as a user belonging to a corporation. The user A1 who has a corporate account including the user ID “0002” has reserved a booth 16 corresponding to a booth ID “B2”. A use period is 10:00 to 11:00 on January 7. Use information C2 is defined as information for using the booth 16 on January 7 from 10:00 to 11:00. The reservation management system 12 transmits the use information C2 to a terminal apparatus 26 used for the reservation.

Reservation management tables are also created for and stored in the service provision systems 14A and 14B. For example, the service provided by the service provision system 14A is reserved, and information regarding the reservation (e.g., information for identifying the service, information indicating a period of time for which the service is used, and information indicating a place where the service is provided) is registered to the reservation management table stored in the service provision system 14A. The same holds for the service provision system 14B.

A process performed when the user uses one of the booths 16 will be described hereinafter. It is assumed here that the user A1 having a personal account uses the booth 16 corresponding to the booth ID “B1”. The booth 16 corresponding to the booth ID “B1” will be referred to as a “booth B1” hereinafter for convenience of description.

When the user A1 performs an operation for using the booth B1, the processor 42 of the reservation management system 12 performs an authentication process in order to check whether use of the booth B1 by the user A1 is permitted.

For example, a door of the booth B1 is locked by an electronic lock. The door is provided with a wireless communication device that performs short-distance wireless communication. When the user A1 holds the terminal apparatus 26A onto the door, the terminal apparatus 26A transmits use information to the wireless communication device through short-distance wireless communication. As described above, the use information has been transmitted from the reservation management system 12 to the terminal apparatus 26A and stored in the memory 48 of the terminal apparatus 26A when the user A1 has reserved the booth B1. Upon receiving the use information from the terminal apparatus 26A, the wireless communication device transmits the use information and the booth ID of the booth B1 to the reservation management system 12 through or not through the booth control apparatus 18. The processor 42 of the reservation management system 12 refers to the reservation management table illustrated in FIG. 6 and checks whether use information (e.g., use information C1) associated with the transmitted booth ID and a use period including present time and the transmitted use information match.

If the transmitted use information and the use information C1 match, the processor 42 of the reservation management system 12 permits the user A1 having a personal account to use the booth B1. In this case, the processor 42 of the reservation management system 12 transmits information indicating an instruction to unlock the door to the wireless communication device provided for the door of the booth B1 through or not through the booth control apparatus 18. The electronic lock is opened in accordance with the instruction to unlock the door. After the electronic lock is opened, the user A1 can open the door and enter the booth B1. The processor 42 of the reservation management system 12 also transmits, to the booth control apparatus 18, information indicating a use period for which the booth B1 can be used using the use information C1. The memory of the booth control apparatus 18 stores the information indicating the use period.

If the transmitted use information and the use information C1 do not match, the processor 42 of the reservation management system 12 does not permit the user A1 to use the booth B1. In this case, the processor 42 of the reservation management system 12 does not transmit information indicating an instruction to unlock the door. The electronic lock on the door of the booth B1, therefore, is not opened.

If the present time is between 10:00 and 11:00 on January 6 and the use information transmitted to the reservation management system 12 and the use information C1 match, for example, the processor 42 of the reservation management system 12 permits the user A1 to use the booth B1. If the present time is between 10:00 and 11:00 on January 6 but the transmitted use information and the use information C1 do not match, the processor 42 of the reservation management system 12 does not permit the user A1 to use the booth B1. If the transmitted use information and the use information C1 match but the present time is not between 10:00 and 11:00 on January 6, the processor 42 of the reservation management system 12 does not permit the user A1 to use the booth B1.

Alternatively, the terminal apparatus 26A may transmit a user ID, a booth ID, and use information to the reservation management system 12. In this case, the processor 42 of the reservation management system 12 checks whether a combination of the transmitted user ID and use information and a combination of a user ID associated with use information C1 and the use information C1 match. If the combinations match, the processor 42 permits the user A1 to use the booth B1, and if the combinations do not match, the processor 42 does not permit the user A1 to use the booth B1.

When an end (e.g., 11:00) of the use period comes, for example, the booth control apparatus 18 transmits information indicating that the use period has ended to the terminal apparatus 26A used by the user A1. The information indicating that the use period has ended is displayed on the UI 46 of the terminal apparatus 26A. Alternatively, the information indicating that the use period has ended may be displayed on a display device provided for the booth B1.

When the end (e.g., 11:00) of the use period comes and the user A1 leaves the booth B1, the electronic lock on the door of the booth B1 is set. After the end of the use period comes, the user A1 can no longer open the electronic lock using the use information C1.

When a booth 16 is used using a personal account, a fee for using the booth 16 is charged to a user having the personal account. In the above example, the fee for using the booth B1 is charged to the user corresponding to the user ID “0001”. The personal payment system 20 makes payment for users having personal accounts. For example, the processor 42 of the reservation management system 12 refers to the reservation management table and creates, for each user having a personal account, use record data, which is data indicating records of use of the booths 16. For example, the processor 42 creates use record data at predetermined time intervals (e.g., every fiscal month). The use record data includes payment data. The payment data is created on the basis of use fees of the booths 16. A use fee may be determined, for example, for each booth 16, in accordance with the length of a use period, or in accordance with a use condition of equipment provided for the booths 16. Even when a booth 16 is not actually used in a reserved use period, a user who has reserved the booth 16 is charged unless the user cancels the reservation for the booth 16. In addition, a repayment process or a discount process may be performed, and payment data that reflects such a process may be created. For example, a manager of the operation management system 10 or the like may perform a repayment process in response to a claim from a user or a discount process based on a sales campaign or the like. The processor 42 transmits use record data regarding each personal user to the personal payment system 20. The personal payment system 20 makes payment for each personal user on the basis of the use record data. For example, the personal payment system 20 makes payment using a registered credit card.

Similarly, when a user uses a service provided by the service provision system 14A or 14B, the personal payment system 20 makes payment. That is, the processor of the service provision system 14A transmits use record data regarding each personal user to the personal payment system 20. The use record data indicates records of use of the service provided by the service provision system 14A. The same holds for the service provision system 14B. The personal payment system 20 individually makes payment for each of services used by personal users. That is, the personal payment system 20 individually makes payment for use of the booths 16 provided by the reservation management system 12, payment for use of the service provided by the service provision system 14A, and use of the service provided by the service provision system 14B.

Now, a process for registering a corporate user to the reservation management system 12 will be described. A case where a corporate user is registered to the reservation management system 12 is an example of a case where a corporate user makes a contract to use the service provided by the reservation management system 12.

First, a contract is made between a corporation and the management company of the operation management system 10 or the like, contract information is created, and services available to users belonging to the corporation are determined. It is assumed, for example, that each user belonging to a corporation α can use the booths 16 provided by the reservation management system 12 and the service provided by the service provision system 14A in accordance with the contract.

Next, the manager of the operation management system 10 registers, to the corporation authentication system 22 using the terminal apparatus 26C, target users belonging to the corporation α and authorized to use the booths 16 provided by the reservation management system 12 (i.e., users who can use the booths 16) and target users belonging to the corporation α and authorized to use the service provided by the service provision system 14A (i.e., users who can use the service). For example, a manager screen is displayed on the UI 46 of the terminal apparatus 26C, and the manager registers the target users to the corporation authentication system 22 on the manager screen. For example, the manager specifies corporation identification information for identifying the corporation α, user information regarding the target users, and information for identifying the services available to the target users. The processor 34 of the operation management system 10 registers these pieces of information to the corporate user management information stored in the corporation authentication system 22. The processor 42 of the reservation management system 12 may register the corporate identification information and the user information (e.g., user identification information or email addresses) regarding the target users who can use the booths 16 to the corporate user management information stored in the corporation authentication system 22. Similarly, the processor of the service provision system 14A may register the corporation identification information and the user information regarding the target users who can use the service provided by the service provision system 14A to the corporate user management information stored in the corporation authentication system 22.

Next, a notification about user registration is transmitted to the target users. For example, the processor 34 of the operation management system 10 transmits, to the target users, the notification about user registration to the services available to the target users as an email or the like. For example, the processor 34 of the operation management system 10 transmits, to the target users authorized to use the booths 16, the notification about user registration to the reservation management system 12 and, to the target users to be authorized to use the service provided by the service provision system 14A, the notification about user registration to the service provision system 14A. Alternatively, the processor 42 of the reservation management system 12 may transmit, to the target users authorized to use the booths 16, the notification about user registration to the reservation management system 12, and the processor of the service provision system 14A may transmit, to the target users authorized to use the service provided by the service provision system 14A, the notification about user registration to the service provision system 14A.

Upon receiving the notification about user registration, the target users register themselves to the services available thereto. The user registration to the reservation management system 12 will be described hereinafter.

Each of the target users accesses the reservation management system 12 using the terminal apparatus 26B and requests the reservation management system 12 to register a corporate user. As a result, the UI 46 of the terminal apparatus 26B displays a screen for registering the user to the reservation management system 12 as a corporate user. The target user inputs information such as a name and an email address thereof and a password on the screen using the terminal apparatus 26B, and the terminal apparatus 26B transmits the information to the reservation management system 12. The processor 42 of the reservation management system 12 registers the information to the personal user management information, creates a corporate account, and issues the corporate account to the target user. For example, the processor 42 creates a user ID associated with the corporate account, registers the user ID in the personal user management information, and transmits the user ID to the terminal apparatus 26B. As a result, the user is notified of the user ID. Alternatively, the user ID may be determined by the user, input to the reservation management system 12, and registered to the personal user management information. The user ID and the password associated with the corporate account are used by the user to log in to the operation management system 10 and the reservation management system 12 using the corporate account. For example, the user ID and the password are transmitted to the corporation authentication system 22 and registered to the corporate user management information. Alternatively, the user ID and the password may be stored in the operation management system 10.

For example, the processor 42 of the reservation management system 12 checks whether the user who requests the reservation management system 12 to register a corporate user is registered in the corporate user management information as a target user authorized to use the service provided by the reservation management system 12. For example, the processor 42 may refer to the corporate user management information or inquire the corporation authentication system 22 about the registration. If the user who has requested the reservation management system 12 to register a corporate user is registered in the corporate user management information as a target user authorized to use the service provided by the reservation management system 12, the processor 42 registers the user as a corporate user. If the user who has requested the reservation management system 12 to register a corporate user is not registered in the corporate user management information as a target user authorized to use the service provided by the reservation management system 12, the processor 42 does not register the user as a corporate user.

As described above, after a target user is registered to the reservation management system 12 as a corporate user and a corporate account is issued, the target user can log in to the operation management system 10 and the reservation management system 12 using the corporate account and reserve the booths 16. That is, the processor 42 of the reservation management system 12 permits corporate users to reserve the booths 16. The same holds for the service provision system 14A.

Alternatively, names and email addresses of corporate users, passwords, and the like may be stored in and managed by the operation management system 10.

Now, the corporate user management information will be described in detail with reference to FIG. 7. FIG. 7 illustrates an example of a corporate user management table, which is an example of the corporate user management information. Data regarding the corporate user management table is stored in the corporation authentication system 22.

On the corporate user management table, for example, a corporate ID, information indicating a name of a corporation, information indicating names of users belonging to a corporation, information indicating email addresses of users, information indicating services available to users, and information indicating presence or absence of use authority given to users are associated with one another for each corporation. A user ID and a password of each user are also registered in the corporate user management table.

The users A1 and A2, for example, are registered as corporate users belonging to the corporation α. The users A1 and A2 are authorized to use the booths 16 provided by the reservation management system 12 and the service provided by the service provision system 14A.

The user A1 is also registered in the reservation management system 12 as a corporate user. As illustrated in FIG. 5, for example, the user A1 is also registered in the personal user management table as a corporate user and given the user ID “0002”. The same holds for the user A2. Since corporate users are not charged, payment means and personal payment accounts are not associated with corporate users.

For example, the user A1 can log in to the reservation management system 12 as a corporate user using the user ID “0002” and a password associated with the user ID and reserve a booth 16. A reservation method used is the same as the method used by a personal user to reserve a booth 16. As illustrated in FIG. 6, for example, the booth 16 having the booth ID “B2” is reserved by the user A1, who is a corporate user. The user A1 can open the electronic lock on the door of the booth 16 using the use information C2 and use the booth 16 as a corporate user on January 7 from 10:00 to 11:00.

The user A1 is also registered in the personal user management table as a personal user. The user A1, therefore, may reserve a booth 16 using a personal account or a corporate account. If a booth 16 is reserved and used using a personal account, the user A1 is charged by the personal payment system 20. If a booth 16 is reserved and used using a corporate account, the user A1 is not charged, and the corporation payment system 24 charges the corporation α, to which the user A1 belongs.

When a corporate user accesses the operation management system 10 using the terminal apparatus 26B, for example, a login screen is displayed on the UI 46 of the terminal apparatus 26B. A field for inputting information (e.g., a user ID and a password) for logging in to the operation management system 10 using a corporate account is displayed in the login screen. The user inputs a user ID and a password on the login screen, and the terminal apparatus 26B transmits the input user ID and password to the corporation authentication system 22 through or not through the operation management system 10. The corporation authentication system 22 authenticates the user who has requested login and, if the authentication is successfully completed, permits the user to log in to the operation management system 10 and, if the authentication fails, does not permit the user to log in to the operation management system 10. For example, if the input user ID and password are registered in the corporate user management table, the corporation authentication system 22 permits the user to log in to the operation management system 10 and if the input user ID and password are not registered in the corporate user management table, the corporation authentication system 22 does not permit the user to log in to the operation management system 10. Alternatively, the operation management system 10 may determine whether to permit the user to log therein.

If login to the operation management system 10 is permitted, the UI 46 of the terminal apparatus 26B displays a service selection screen. The service selection screen includes a list of services available to the user A1, who has logged in to the operation management system 10. For example, the processor 34 of the operation management system 10 refers to the corporate user management table and identifies services available to the user A1 and then displays a list of the identified services in the service selection screen.

When the user A1 selects a service on the service selection screen, a screen for reserving the selected service is displayed on the UI 46 of the terminal apparatus 26B. When a booth 16 is selected, for example, the screen for reserving the booths 16 is displayed on the UI 46 of the terminal apparatus 26B. The user A1 can reserve a booth 16 on the screen.

As illustrated in FIG. 6, for example, the user A1, who is a corporate user having the corporate account including the user ID “0002”, reserves the booth 16 having the booth ID “B2”. A use period is 10:00 to 11:00 on January 7. Use information C2 is defined as information for using the booth 16 on January 7 from 10:00 to 11:00. The use information C2 is transmitted from the reservation management system 12 to the terminal apparatus 26B used for the reservation.

A process performed when the user A1, who is a corporate user, uses the booth 16 is the same as the process performed when a personal user uses a booth 16, but a payment method is different. When a booth 16 is used using a corporate account, a fee for using the booth 16 is charged to the corporation α to which the user A1 having the corporate account belongs. The corporation payment system 24 makes payment for corporations. The processor of each service provision system creates, for each corporation, use record data indicating records of use of the service provided by the service provision system. For example, the processor 42 of the reservation management system 12 refers to the reservation management table and creates, for each corporation, use record data indicating records of use of the booths 16. In a specific example, the processor 42 of the reservation management system 12 creates use record data indicating records of use by all users belonging to the corporation α. The same holds for other corporations. The same also holds for the service provision systems 14A and 14B. For example, the processor of each service provision system creates use record data for each fiscal month. The use record data includes payment data. The payment data is created on the basis of a fee for using the service. The use fee may be determined, for example, for each service, in accordance with the length of a use period, or in accordance with a use condition of equipment. Even when the service is not actually used in a reserved use period, a user who has reserved the service is charged unless the reservation for the service has been canceled. In addition, a repayment process or a discount process may be performed, and payment data that reflects such a process may be created. For example, the manager of the operation management system 10 or the like may perform a repayment process in response to a claim from a user or a discount process based on a sales campaign or the like.

Use record data regarding all services used by every user belonging to each corporation is transmitted to the corporation payment system 24. The transmission is performed under control of the operation management system 10. The operation management system 10 has been informed of records of use of the service provided by each service provision system, and each service provision system transmits use record data regarding each corporation to the corporation payment system 24 in accordance with an instruction from the operation management system 10.

The corporation payment system 24 makes payment for each corporation on the basis of the use record data. The corporation payment system 24 calculates, for each corporation, the sum of use fees indicated by the use record data regarding all the services and charges the sum to the corporation. When the users belonging to the corporation α use the booths 16 and the service provided by the service provision system 14A, for example, use record data regarding the booths 16 and use record data regarding the service provided by the service provision system 14A are transmitted to the corporation payment system 24. The corporation payment system 24 calculates the sum of use fees indicated by the use record data regarding the booths 16 and use fees indicated by the use record data regarding the service provided by the service provision system 14A and charges the sum to the corporation α. Payment for all the services is thus collectively made for each corporation. The sum of use fees may be calculated by the operation management system 10, the reservation management system 12, or another service provision system. It is needless to say that payment may be made for each service.

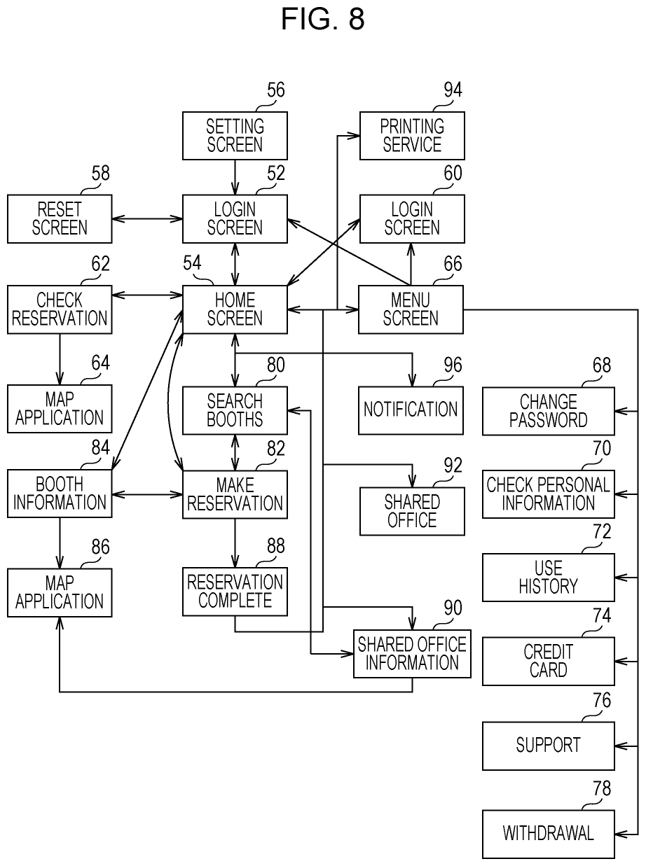

Screen transitions on the UI 46 of the terminal apparatus 26 will be described hereinafter with reference to FIG. 8. FIG. 8 illustrates the screen transitions.

First, if a personal user activates the presentation application using the terminal apparatus 26, the UI 46 of the terminal apparatus 26 displays a login screen 52 for a personal user. The personal user logs in to the reservation management system 12 by inputting a user ID and a password associated with a personal account on the login screen 52, and the UI 46 displays a home screen 54. If a personal account has not been created, a setting screen 56 for creating a personal account is displayed, and the personal user sets a user ID and a password on the setting screen 56. If the personal user forgets the password, the UI 46 displays a reset screen 58 for a personal user, and the personal user can reset the password on the reset screen 58.

If a corporate user activates the presentation application using the terminal apparatus 26, on the other hand, the UI 46 of the terminal apparatus 26 displays a login screen 60 for a corporate user. The corporate user logs in to the reservation management system 12 by inputting a user ID and a password associated with a corporate account on the login screen 60, and the UI 46 displays the home screen 54. Alternatively, if the corporate user logs in to the operation management system 10, the UI 46 may display the service selection screen. If the corporate user selects use of a booth 16 on the service selection screen, the UI 46 may display the home screen 54.

As indicated by a reference numeral 62, for example, the user can check a reservation for a booth 16 and a current booth 16 on the home screen 54. As indicated by a reference numeral 64, the user may also activate a map application using the terminal apparatus 26. When the map application is activated, for example, the UI 46 of the terminal apparatus 26 displays a map indicating positions of the booths 16.

A menu button is displayed on the home screen 54, and when the user presses the menu button, the UI 46 of the terminal apparatus 26 displays a menu screen 66. On the menu screen 66, the user can log out of the reservation management system 12. When a personal user logs out, the login screen 52 for a personal user is displayed, and when a corporate user logs out, the login screen 60 for a corporate user is displayed.

The menu screen 66 includes various menus. For example, the menu screen 66 includes a menu 68 for changing a personal user's password, a menu 70 for checking and correcting personal information regarding a personal user, a menu 72 for referring to a use history, a menu 74 for registering and changing credit card information regarding a personal user, a menu 76 relating to support, and a menu 78 for withdrawing a personal user. The user selects one of these menus to perform a desired operation or process.

When the user presses a button for returning to the home screen 54 on the menu screen 66, or when an operation or a process has been completed in a menu, the UI 46 of the terminal apparatus 26 displays the home screen 54.

As indicated by a reference numeral 80, the user can search for booths 16 on the home screen 54. For example, the user can search for booths 16 using places where the booths 16 are installed, reservable times, use fees, or the like as search keys. The terminal apparatus 26 transmits information indicating the search keys to the reservation management system 12, and the processor 42 of the reservation management system 12 searches for booths 16 that match the search keys and transmits information indicating a result of the search to the terminal apparatus 26. The UI 46 displays information regarding the found booths 16. Alternatively, a current booth 16, a reserved booth 16, booths 16 installed near the position of the user, or the like may be searched for, and a result of the search may be displayed on the UI 46.

When the user selects a booth 16 on a list of booths 16 as indicated by a reference numeral 82, the UI 46 of the terminal apparatus 26 displays information regarding the selected booth 16 as indicated by a reference numeral 84. Alternatively, the UI 46 may display information regarding a current booth 16, a reserved booth 16, or booths 16 installed near the position of the user. As indicated by a reference numeral 86, a map application may be activated, and a map indicating the positions of the booths 16 may be displayed.

When the user specifies a booth 16 and a time to use the booth 16 using the terminal apparatus 26 and requests a reservation, the reservation is completed as indicated by a reference numeral 88. For example, the terminal apparatus 26 transmits information indicating a request for a reservation to the reservation management system 12, and the reservation is registered to the reservation management table illustrated in FIG. 6. When the reservation is completed, the screen switches to the home screen 54.

In the example illustrated in FIG. 8, the presentation application that presents the booths 16 presents shared offices and printing services on the home screen 54 as cooperative services. Both the shared offices and the printing services may be presented as cooperative services, or either the shared offices or the printing services may be presented as cooperative services.

For example, the shared offices are services provided by the service provision system 14A, and the service provision system 14A manages reservations for the shared offices.

The printing services are services provided by the service provision system 14B, and the service provision system 14B manages reservations for the printing services.

When the user requests a search for shared offices on the home screen 54 as indicated by the reference numeral 80, for example, the UI 46 of the terminal apparatus 26 displays a screen for searching for shared offices. The user can search for shared offices on the search screen. For example, the user can search for shared offices using places of the shared offices, reservable times, use fees, or the like as search keys. The terminal apparatus 26 transmits information indicating the search keys to the service provision system 14A through or not through the reservation management system 12. The service provision system 14A searches for shared offices that match the search keys and transmits information indicating a result of the search to the terminal apparatus 26. As indicated by a reference numeral 90, the UI 46 displays information regarding the found shared offices. Alternatively, shared offices located within a predetermined distance from each booth 16 may be searched for, and information regarding the found shared offices may be associated with the booth 16 and displayed. As indicated by the reference numeral 86, a map application may display a map indicating positions of the shared offices.

When the user requests a reservation for a shared office using the terminal apparatus 26, the UI 46 of the terminal apparatus 26 displays a screen 92 for reserving a shared office. The screen 92 is different from the home screen 54. For example, the processor 50 of the terminal apparatus 26 transmits information indicating a request made on the screen 92 for reserving a shared office to the service provision system 14A. The processor of the service provision system 14A transmits information regarding the screen 92 for reserving a shared office to the terminal apparatus 26 in accordance with the request. The UI 46 of the terminal apparatus 26 displays the screen 92. The screen 92 may be a website. When the user requests a reservation for a shared office, for example, the processor 50 of the terminal apparatus 26 accesses an address (e.g., a uniform resource locator (URL)) of the screen 92 for reserving a shared office and displays the screen 92 on the UI 46. The user can reserve a shared office on the screen 92. Alternatively, a screen for logging in to the service provision system 14A, which provides the shared offices, may be displayed before the screen 92 is displayed. When the user logs in to the service provision system 14A by inputting a user ID and a password on the screen, the screen 92 is displayed. When single sign-on is enabled, the screen 92 is displayed without this login operation.

When the user requests a reservation for a printing service using the terminal apparatus 26, on the other hand, the UI 46 of the terminal apparatus 26 displays a screen 94 for reserving a printing service. The screen 94 is different from the home screen 54. For example, the processor 50 of the terminal apparatus 26 transmits information indicating a request made on the screen 94 for reserving a printing service to the service provision system 14B. The processor of the service provision system 14B transmits information regarding the screen 94 for reserving a printing service to the terminal apparatus 26 in accordance with the request. The UI 46 of the terminal apparatus 26 displays the screen 94. The screen 94 may be a website. When the user requests a reservation for a printing service, for example, the processor 50 of the terminal apparatus 26 accesses an address (e.g., a URL) of the screen 94 for reserving a printing service and displays the screen 94 on the UI 46. The user can reserve a printing service on the screen 94. Alternatively, a screen for logging in to the service provision system 14B that provides the printing services may be displayed before the screen 94 is displayed. When the user logs in to the service provision system 14B by inputting a user ID and a password on the screen, the screen 94 is displayed. When single sign-on is enabled, the screen 94 is displayed without this login operation.

As indicated by a reference numeral 96, the home screen 54 may display information (e.g., a notification) to be shared by the user.

More specific examples will be described hereinafter.

### First Example

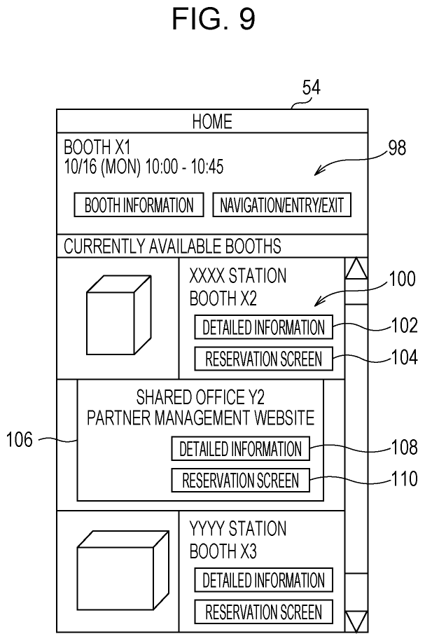

A first example will be described hereinafter with reference to FIG. 9. In the first example, shared offices are presented as cooperative services. For example, the service provision system 14A manages reservations for the shared offices.

FIG. 9 illustrates an example of a home screen. When a user A logs in to the reservation management system 12, the processor 50 of the terminal apparatus 26 displays the home screen 54 on the UI 46 of the terminal apparatus 26. For example, the processor 50 receives information regarding the home screen 54 from the reservation management system 12 and displays the home screen 54 on the UI 46. As indicated by a reference numeral 98, for example, information regarding a booth 16 (e.g., a booth X1) reserved by the user A, information regarding a booth 16 that is being used by the user A, and the like are displayed on the home screen 54. The information regarding the booth X1 includes, for example, information indicating a name of the booth X1, information indicating a place where the booth X1 is installed, and information indicating a reserved time. The processor 50 of the terminal apparatus 26 receives these pieces of information from the reservation management system 12 and displays these piece of information in the home screen 54. The information regarding the booth X1 reserved by the user A is registered in the reservation management table.

As indicated by a reference numeral 100, information regarding other booths 16 (e.g., booths X2 and X3) is displayed on the home screen 54. For example, the processor 50 of the terminal apparatus 26 receives, from the reservation management system 12, information regarding currently available booths 16 installed at places within a predetermined distance from a position of the user A and displays a list of the booths 16 on the home screen 54. The position of the user A is a position of the terminal apparatus 26 used by the user A. The currently available booths 16 (e.g., the booths X2 and X3) are currently reservable booths 16 that have not been reserved. For example, the currently available booths 16 are booths 16 that have not been reserved for use in a predetermined period of time from the present time, that is, booths 16 that can be reserved for use in the predetermined period of time from the present time. When the present time is 9:30, for example, information regarding booths 16 that have not been reserved for use in 9:00 to 11:00 is displayed as information regarding currently available booths 16. Alternatively, images of the booths 16 may be displayed.

Buttons 102 for displaying detailed information and buttons 104 for displaying a reservation screen are displayed on the home screen 54 for the booths X2 and X3, respectively.

When the user presses the button 102 for the booth X2, for example, the processor 50 of the terminal apparatus 26 receives detailed information regarding the booth X2, for which the button 102 is displayed, from the reservation management system 12 and displays the detailed information on the UI 46 of the terminal apparatus 26. For example, a screen different from the home screen 54 is displayed in the UI 46, and the detailed information is displayed on the screen. The detailed information includes, for example, information indicating an address of a place where the booth X2 is installed, information indicating the place where the booth X2 is installed (e.g., information indicating a name of a station when the booth X2 is installed in a station), a map indicating a position of the booth X2, and information regarding equipment provided for the booth X2. The same holds for the booth X3.

When the user presses the button 104 for the booth X2, the processor 50 of the terminal apparatus 26 displays the reservation screen, which is a screen for reserving the booth X2 for which the display unit 104 is displayed, on the UI 46 of the terminal apparatus 26. For example, a reservation screen different from the home screen 54 is displayed. If the user A specifies a time and the like and requests a reservation on the reservation screen, the terminal apparatus 26 transmits information indicating the request to the reservation management system 12, and the reservation management system 12 completes the reservation. The reservation is registered to the reservation management table stored in the reservation management system 12. The user A can use the reserved booth X2 at the reserved time.

The processor 50 of the terminal apparatus 26 displays, on the home screen 54, information regarding a shared office while associating the information with the booths 16 as an example of information regarding a cooperative service. For example, a display area 106, such as a window, is displayed in the home screen 54 for the booths 16, and the information regarding the shared office is displayed in the display area 106. For example, the information regarding the shared office includes information indicating a name of the shared office and information indicating that the shared office is a service provided by the service provision system 14A, which is different from the reservation management system 12. A provision company or the like that provides the booths 16 using the reservation management system 12 is an example of a provider of places. A provision company or the like that provides shared offices using the service provision system 14A is an example of another provider that provides shared offices in association with the booths 16. The shared offices provided by the service provision system 14A are an example of services provided by the other provider. The processor 50 thus notifies the user that the shared office is a service provided by another provider. For example, a name of an affiliated site that is provided by the service provision system 14A and that is used to reserve the shared office or the like is displayed as the information regarding the shared office. The processor 50 receives the information regarding the shared office from the service provision system 14A through or not through the reservation management system 12 and displays the information in the home screen 54. Alternatively, the processor 50 may receive the information regarding the shared office on the operation management system 10 and display the information in the home screen 54.

The booths 16 that are candidates for reservation and the shared office, which is an example of a service that is a candidate for use, are thus displayed on the same home screen 54 and presented by the same presentation application. The booths 16 and the shared office to be presented change in association with each other.

For example, the processor 50 receives, from the service provision system 14A, information regarding shared offices (e.g., a shared office Y2) located at a place within a predetermined distance from a place where the currently available booth X2 is installed and displays the information in the home screen 54 for the booth X2. The display area 106 is associated with the booth X2, and the information regarding the shared office Y2 is displayed in the display area 106. The same holds for the booth X3, that is, information regarding shared offices (e.g., a shared office Y3) located at a place within the predetermined distance from a place where the booth X3 is installed is displayed in a display area of the home screen 54 associated with the booth X3. A different shared office is thus presented for each booth 16. When a booth 16 to be presented changes, a shared office to be presented also changes.

For example, a button 108 for displaying detailed information and a button 110 for displaying a reservation screen are displayed in the display area 106 for the shared office Y2.

When the user A presses the button 108, the processor 50 of the terminal apparatus 26 receives the detailed information regarding the shared office Y2 from the service provision system 14A through or not though the reservation management system 12 and displays the detailed information on the UI 46 of the terminal apparatus 26. For example, a screen different from the home screen 54 is displayed on the UI 46, and the detailed information is displayed on the screen. The detailed information includes, for example, information indicating an address of a place where the shared office Y2 is located, information indicating the place where the shared office Y2 is located (e.g., information indicating a name of a building in which the shared office Y2 is located), and a map indicating a position of the shared office Y2, and information regarding equipment provided for the shared office Y2.

When the user A presses the button 110, the processor 50 of the terminal apparatus 26 displays the reservation screen, which is a screen for reserving the shared office Y2, on the UI 46 of the terminal apparatus 26. For example, a reservation screen different from the home screen 54 is displayed on the UI 46. For example, the reservation screen is a website, and an address (e.g., a URL) of the website is associated with the button 110. When the user presses the button 110, the processor 50 accesses the address of the website and displays the reservation screen on the UI 46. If the user A specifies a time and the like and requests a reservation on the reservation screen, the terminal apparatus 26 transmits information indicating the request to the service provision system 14A, and the service provision system 14A completes the reservation. The reservation is registered to the reservation management table stored in the service provision system 14A. The user A can use the reserved shared office Y2 at the reserved time. When the user needs to log in to the service provision system 14A, a login screen is displayed before the reservation screen is displayed. When the user A logs in to the service provision system 14A by inputting a user ID and a password on the login screen, the reservation screen is displayed. A screen for searching for shared offices may be displayed as a screen different from the home screen 54.

The operation management system 10, the reservation management system 12, or the service provision system 14A may provide the home screen 54 and the information (e.g., the information regarding the booths 16 and the information regarding the shared office) displayed on the home screen 54 illustrated in FIG. 9 for the terminal apparatus 26, and the UI 46 of the terminal apparatus 26 may display the home screen 54 and the information. The booths 16 and the shared office, which is a cooperative service, may thus be presented by one of these systems, instead.

The booths 16 may be installed in shared offices. That is, the cooperative service may be a service for providing a shared office including booths 16. In this case, the booths 16 are an example of first places, and the shared offices are an example of second places.

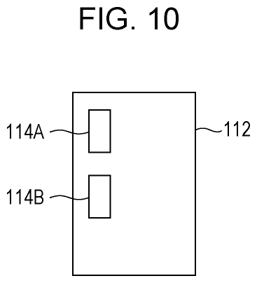

FIG. 10 schematically illustrates a relationship between booths 16 and a shared office. Booths 114A and 114B, for example, are installed in a shared office 112. If a user (e.g., the user A) reserves the shared office 112, for example, users other than the user A may be inhibited from reserving the booths 114A and 114B installed in the shared office 112. More specifically, the users other than the user A are inhibited from reserving the booths 114A and 114B at a reserved time of the shared office 112.

For example, information indicating that the booths 114A and 114B are installed in the shared office 112 is stored in and shared by the reservation management system 12 that provides the booths 114A and 114B and the service provision system 14A that provides the shared office 112.

Information regarding the user (e.g., the user A) who has reserved the shared office 112 and information indicating a reserved time are stored in the service provision system 14A and shared by the reservation management system 12.

The processor 42 of the reservation management system 12 inhibits the users other than the user A from reserving the booths 114A and 114B at the reserved time of the shared office 112 and permits the user A to reserve the booths 114A and 114B. As a result, the users other than the user A are prevented from reserving the booths 114A and 114B. For example, even if a user other than the user A logs in to the reservation management system 12 and requests a reservation for the booth 114A or 114B at the reserved time of the shared office 112, the processor 42 of the reservation management system 12 does not accept the request to inhibit the user from reserving the booth 114A or 114B.

In another example, if the user (e.g., the user A) reserves the shared office 112 and a booth (e.g., the booth 114A) installed in the shared office 112, the users other than the user A may be inhibited from reserving another booth (e.g., the booth 114B) installed in the shared office 112.

The processor 42 of the reservation management system 12 inhibits the users other than the user A from reserving the booth 114B at the reserved time of the shared office 112 and permits the user A to reserve the booth 114B. As a result, the users other than the user A are prevented from reserving the booth 114B.

### Second Example

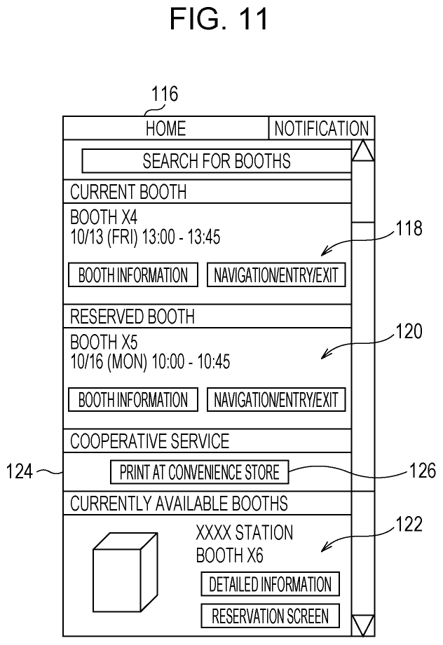

A second example will be described hereinafter with reference to FIGS. 11 to 14. In the second example, a printing service is presented as an example of a cooperative service. A printing service is, for example, a service for downloading data (e.g., image data or text data) stored in a server, a cloud computer, or the like onto a printer and printing the data using the printer. The printer is, for example, installed in a store. For example, the service provision system 14B manages reservations for the printing service. An MFP having a scanning function, a copying function, and the like as well as a printing function may be used for the printing service.

FIG. 11 illustrates an example of a home screen. When the user A logs in to the reservation management system 12, the processor 50 of the terminal apparatus 26 displays a home screen 116 on the UI 46 of the terminal apparatus 26. As indicated by a reference numeral 118, for example, information regarding a booth 16 (e.g., a booth X4) that is being used by the user A is displayed in the home screen 116. As indicated by a reference numeral 120, for example, information regarding a booth 16 (e.g., a booth X5) that has been reserved by the user A but whose reserved time has not come is displayed in the home screen 116. The processor 50 of the terminal apparatus 26 receives these pieces of information from the reservation management system 12 and displays these pieces of information in the home screen 116. These pieces of information are registered in the reservation management table.

As indicated by a reference numeral 122, for example, information regarding another booth 16 (e.g., a booth X6) is displayed in the home screen 116. For example, the processor 50 of the terminal apparatus 26 receives, from the reservation management system 12, information regarding currently available booths 16 (e.g., the booth X6) installed at places within a predetermined distance from the position of the user A and displays a list of the booths 16 in the home screen 116. The currently available booths 16 (e.g., the booth X6) are currently reservable booths 16 that have not been reserved. As in the home screen 54 illustrated in FIG. 9, a button for displaying detailed information and a button for displaying a reservation screen are displayed for the currently available booths 16.

As indicated by a reference numeral 124, the processor 50 of the terminal apparatus 26 displays information regarding the printing service on the home screen 54 as information regarding a cooperative service. The printing service provided here is a service for performing printing using a printer installed in a convenience store.

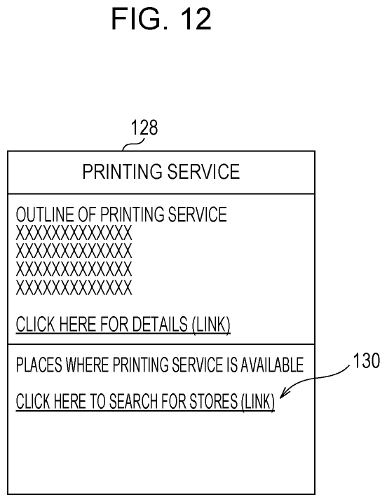

For example, a button 126 for using the printing service is displayed in the home screen 116. When the user A presses the button 126, the processor 50 of the terminal apparatus 26 displays a screen 128 for using the printing service on the UI 46 of the terminal apparatus 26 as illustrated in FIG. 12. The screen 128 is a screen different from the home screen 116. For example, the screen 128 is a website, and an address of the website is associated with the button 126. When the user presses the button 126, the processor 50 accesses the address of the website to display the screen 128 on the UI 46. When the user A needs to log in to the service provision system 14B that provides the printing service, a login screen is displayed on the UI 46 before the screen 128 is displayed. When the user A logs in to the service provision system 14B by inputting a user ID and a password on the login screen, the screen 128 is displayed on the UI 46.

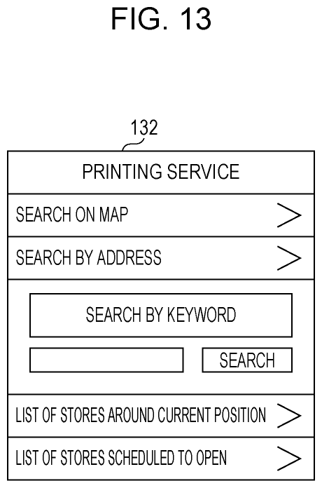

A link 130 to a website for searching for stores where the printing service is available, for example, is provided on the screen 128. An address of the website is associated with the link 130. When the user selects the link 130 to request access to the website (e.g., when the user taps or clicks on the link 130), the processor 50 of the terminal apparatus 26 accesses the website and displays a search screen 132, which is a screen for searching for stores, on the UI 46 of the terminal apparatus 26 as illustrated in FIG. 13.

The user can input a search key on the search screen 132 and search for stores where the printing service is available. A search key is, for example, a position on a map, an address, a keyword, or the like. The terminal apparatus 26 transmits the search key to the service provision system 14B. The processor of the service provision system 14B searches, on the basis of the search key, for stores where the printing service is available and transmits information indicating a result of the search to the terminal apparatus 26. The UI 46 of the terminal apparatus 26 displays the information indicating the result of the search.

The user can also search for stores around a current position thereof, stores scheduled to open, and the like. For example, the processor 50 of the terminal apparatus 26 obtains information indicating a current position of the terminal apparatus 26 using a GPS or the like and transmits the information to the service provision system 14B. The processor of the service provision system 14B searches for stores located within a predetermined distance from the current position of the terminal apparatus 26 and transmits information indicating a result of the search to the terminal apparatus 26.

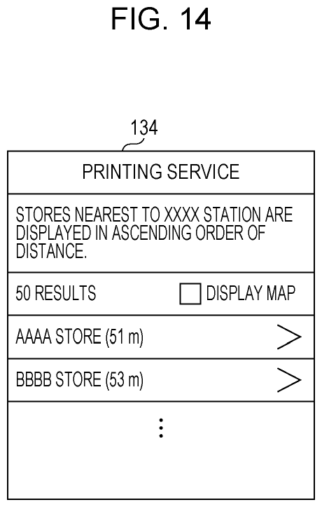

FIG. 14 illustrates an example of a screen indicating a result of a search. A search result screen 134 is an example of the screen indicating a result of a search for stores and displayed on the UI 46 of the terminal apparatus 26. For example, stores located around the current position of the terminal apparatus 26 (e.g., stores located within a predetermined distance from the current position of the terminal apparatus 26) are searched for and displayed in the search result screen 134.

The user A can select a store on the search result screen 134 and reserve a printing service using a printer installed in the store. When the user A selects a store, for example, the UI 46 of the terminal apparatus 26 displays a reservation screen, which is a screen for reserving a printing service using a printer installed in the store. When the user specifies a time and requests a reservation on the reservation screen, the terminal apparatus 26 transmits information indicating the request to the service provision system 14B, and the service provision system 14B completes the reservation. The reservation is registered to the reservation management table stored in the service provision system 14B. The user A can use the reserved printer at the reserved time.

### Modifications

Modifications will be described hereinafter.

If a reservation for a booth 16 is canceled after the booth 16 and a cooperative service are reserved, the reservation for the cooperative service may also be canceled. If the user A reserves the booth X2 on the home screen 54 illustrated in FIG. 9 and then reserves the shared office Y2 presented in association with the booth X2, for example, the reservation management system 12 and the service provision system 14A share information with each other. As a result, the reservation for the booth X2 and the reservation for the shared office Y2 are associated with each other and registered to the reservation management tables stored in the reservation management system 12 and the service provision system 14A.

If the user A requests cancellation of the reservation for the booth X2 using the terminal apparatus 26, the terminal apparatus 26 transmits information indicating the request to the reservation management system 12. The processor 42 of the reservation management system 12 cancels the reservation for the booth X2 in accordance with the request. The processor 42 of the reservation management system 12 transmits the information indicating the request to the service provision systems 14A and 14B. The processors of the service provision systems 14A and 14B cancel reservations for cooperative services associated with the canceled reservation for the booth X2. For example, the reservation for the shared office Y2 is associated with the reservation for the booth X2 and registered in the reservation management table stored in the service provision system 14A. The processor of the service provision system 14A, therefore, cancels the reservation for the shared office Y2.

Alternatively, reservations for cooperative services need not be automatically canceled but may be canceled in accordance with the user's request. If the user A requests cancellation of the reservation for the booth X2, for example, the processor 42 of the reservation management system 12 transmits, to the terminal apparatus 26, information indicating that the shared office Y2 has been reserved in association with the booth X2. The processor 50 of the terminal apparatus 26 displays the information on the UI 46. If the user A requests cancellation of the reservation for the shared office Y2, the terminal apparatus 26 transmits information indicating the request to the service provision system 14A, and the processor of the service provision system 14A cancels the reservation for the shared office Y2.

Another modification will be described. When a booth 16 is reserved, the processor 50 of the terminal apparatus 26 may present cooperative services available on a route to the booth 16. Here, a case where a printing service is presented as a cooperative service will be described as an example. For example, the processor 50 of the terminal apparatus 26 transmits information indicating a reference position to the reservation management system 12. The reference position is, for example, the current position of the terminal apparatus 26 used to reserve a booth 16, a position specified by the user, or the position of the terminal apparatus 26 at a time when a booth 16 has been reserved. The processor 42 of the reservation management system 12 transmits the information indicating the reference position and information indicating a position of the reserved booth 16 to the service provision system 14B. The processor of the service provision system 14B searches for printing services available on a route to the position of the reserved booth 16 from the reference position. For example, the processor of the service provision system 14B searches for stores that are located on the route to the reserved booth 16 and that can provide a printing service or stores that are located within a predetermined range from the route and that can provide a printing service and transmits information indicating a result of the search to the terminal apparatus 26. The processor 50 of the terminal apparatus 26 displays the information indicating the result of the search on the UI 46 of the terminal apparatus 26.

The route may be one expected to be used by the user who has reserved the booth 16. For example, the route may be determined in accordance with a schedule of movement of the user. The terminal apparatus 26, the service provision system, or the operation management system 10 may make the determination.

Another modification will be described. When a booth 16 and cooperative services are used, a fee for using the booth 16 and fees for using the cooperative services may be added up and charged to the user who has reserved the booth 16 and the cooperative services. When the user is a personal user, for example, the processor 42 of the reservation management system 12 transmits data regarding a record of use of the booth 16 by the user to the personal payment system 20, and the processors of the service provision systems 14A and 14B transmit data regarding records of use of the cooperative services by the user to the personal payment system 20. The personal payment system 20 adds up the fee for using the booth 16 and the fees for using the cooperative services on the basis of the data regarding the records of use and charges the fees to the user. For example, payment is made using a credit card associated with the user. When a booth 16 and cooperative services are used using a corporate account, too, the corporation payment system 24 adds up fees for using the booth 16 and a fee for using the cooperative services and charges the fees to a corporation.

Another modification will be described. When a booth 16 is reserved using a corporate account, a corporate user who will use the reserved booth 16 may be permitted to use cooperative services using a personal account of the corporate user. For example, a corporate user who uses a booth 16 using a corporate account can log into the service provision systems 14A and 14B using a personal account thereof and use cooperative services provided by the service provision systems 14A and 14B. In this case, fees for the cooperative services used using the personal account are charged to the corporate user. The processors of the service provision systems 14A and 14B transmit data regarding records of use of the cooperative services by the corporate user to the personal payment system 20, and the personal payment system 20 charges the fees for using the cooperative services to the corporate user on the basis of the data regarding the records of use. For example, payment is made using a credit card associated with the corporate user. Since the booth 16 has been reserved using a corporate account, the fee for using the booth 16 is charged to a corporation to which the corporate user belongs. The corporation payment system 24 makes payment.

When a booth 16 is reserved using a personal account, on the other hand, cooperative services may be used using a corporate account. In this case, a fee for using the booth 16 is charged to a user who has the personal account, and fees for using the cooperative services are charged to a corporation to which the user belongs.

Another modification will be described. When a booth 16 has been reserved and a fee for using the booth 16 changes depending on whether the user uses a cooperative service, the processor 50 of the terminal apparatus 26 may notify the user that the fee for using the booth 16 changes depending on whether the user uses a cooperative service. For example, the processor 50 of the terminal apparatus 26 receives information indicating the fee for using the reserved booth 16 from the reservation management system 12 and information indicating a fee for using the cooperative service reserved in associated with the booth 16 from the service provision system 14A or 14B. If the sum of the fees is higher than the fee for using the booth 16, the processor 50 of the terminal apparatus 26 displays, on the UI 46 of the terminal apparatus 26, information indicating that the sum of the fees is higher than the fee for using the booth 16.

In the above-described first and second examples, the processor 50 of the terminal apparatus 26 presents a shared office or a printing service, which is an example of a cooperative service, in association with a booth 16. For example, the processor 50 presents a shared office or a printing service available within a predetermined range of distance from a position of a booth 16.

In another example, the processor 50 of the terminal apparatus 26 may present a booth 16 in association with a service other than the booths 16. For example, the processor 50 presents, in association with a service other than the booths 16, candidates for a booth 16 to be reserved in order to use the service.

When the user logs in to the service provision system 14A that provides shared offices using the terminal apparatus 26, for example, a home screen for using the shared offices is displayed on the UI 46 of the terminal apparatus 26. A shared office that is being used by the user, a shared office reserved by the user, and shared offices located within a predetermined distance from the position of the user, for example, may be displayed on the home screen. If the user specifies a shared office and requests display of detailed information on the home screen, the processor 50 of the terminal apparatus 26 receives detailed information regarding the shared office from the service provision system 14A and displays the detailed information on the UI 46. When the user specifies a shared office and requests a reservation, a reservation screen for reserving the shared office is displayed on the UI 46, and the user can reserve the shared office on the reservation screen. The service provision system 14A manages the reservation.

The processor 50 of the terminal apparatus 26 receives, from the reservation management system 12 for each shared office, information regarding booths 16 installed at places within a predetermined distance from the shared office and displays the information regarding the booths 16 on the home screen for the shared office. If the user specifies a booth 16 and requests display of detailed information on the home screen, the processor 50 receives the detailed information regarding the booth 16 from the reservation management system 12 and displays the detailed information regarding the booth 16 on the UI 46. When the user specifies a booth 16 and requests a reservation on the home screen, a reservation screen for reserving the booth 16 is displayed on the UI 46, and the user can reserve the booth 16 on the reservation screen. The reservation management system 12 manages the reservation.

The user may switch a reference from a booth 16 to another service or from another service to a booth 16.

In the above-described examples and modifications, the user may select cooperative services of plural types. For example, both information regarding shared offices and information regarding printing services may be displayed on the home screen 54 illustrated in FIG. 9 as information regarding cooperative services, instead. If the user reserves plural booths 16 and cooperative services, a screen for searching for cooperative services may be displayed for each booth 16 near a position at which information regarding the booth 16 is displayed.

In the embodiment above, the term “processor” refers to hardware in a broad sense. Examples of the processor include general processors (e.g., CPU: Central Processing Unit) and dedicated processors (e.g., GPU: Graphics Processing Unit, ASIC: Application-Specific Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
present a place that is a candidate for reservation and a service that is a candidate for use using a same application,
wherein the place and the service to be presented change in association with each other.

2. The information processing apparatus according to claim 1,
wherein the processor is configured to change the place and the service to be presented in accordance with a relationship between the place that is a candidate for reservation and a place where the service that is a candidate for use is provided.

3. The information processing apparatus according to claim 2,
wherein the processor is configured to change the service to be presented in accordance with a relationship between a currently available place that is a candidate for reservation and the place where the service that is a candidate for use is provided.

4. The information processing apparatus according to claim 3,
wherein the processor is configured to change the service to be presented in accordance with a relationship between a currently available place that is a candidate for reservation and that is located within a predetermined range from a position of a user and the place where the service that is a candidate for use is provided.

5. The information processing apparatus according to claim 1,
wherein the processor is also configured to notify a user that the service to be presented is a service provided, in association with the place, by a provider different from a provider of the place.

6. The information processing apparatus according to claim 2,
wherein the processor is also configured to notify a user that the service to be presented is a service provided, in association with the place, by a provider different from a provider of the place.

7. The information processing apparatus according to claim 3,
wherein the processor is also configured to notify a user that the service to be presented is a service provided, in association with the place, by a provider different from a provider of the place.

8. The information processing apparatus according to claim 4,
wherein the processor is also configured to notify a user that the service to be presented is a service provided, in association with the place, by a provider different from a provider of the place.

9. The information processing apparatus according to claim 1,
wherein the service to be presented is a service for providing a second place including a first place, which is the place that is a candidate for reservation, and
wherein, if the second place is reserved, users other than a user who has reserved the second place are inhibited from reserving the first place included in the second place.

10. The information processing apparatus according to claim 2,
wherein the service to be presented is a service for providing a second place including a first place, which is the place that is a candidate for reservation, and
wherein, if the second place is reserved, users other than a user who has reserved the second place are inhibited from reserving the first place included in the second place.

11. The information processing apparatus according to claim 1,
wherein the service to be presented is a service for providing a second place including a first place, which is the place that is a candidate for reservation,
wherein the second place includes a plurality of first places, and
wherein, if one of the plurality of first places included in the second place and the second place are reserved, users other than a user who has reserved the first and second places are inhibited from reserving others of the plurality of first places included in the second place.

12. The information processing apparatus according to claim 1,
wherein, if the place and the service are reserved but a reservation for the place is canceled, a reservation for the service is also canceled.

13. The information processing apparatus according to claim 1,
wherein the processor is also configured to, if the place is reserved, present a service available on a route to the place.

14. The information processing apparatus according to claim 1,
wherein a fee for using the place and a fee for using the service are added up and charged to a user who has reserved the place and the service.

15. The information processing apparatus according to claim 1,
wherein a personal account, which is an account for a personal user to use the place and the service, and an organization account, which is an account for a user belonging to an organization to use the place and the service, are defined, and
wherein, if the place is reserved using the organization account, a user belonging to the organization who will use the reserved place is permitted to use the service using a personal account of the user.

16. The information processing apparatus according to claim 1,
wherein the processor is also configured to, in a case where the place is reserved and a use fee changes if the service is provided, the user is notified that the use fee changes if the service is provided.

17. The information processing apparatus according to claim 1,
wherein the processor is also configured to present the service that is a candidate for use in association with the place that is a candidate for reservation.

18. The information processing apparatus according to claim 1,
wherein the processor is also configured to present a candidate for a place to be reserved in order to use the service in association with the service that is a candidate for use.

19. A non-transitory computer readable medium storing a program causing a computer to execute a process comprising:
presenting a place that is a candidate for reservation and a service that is a candidate for use using a same application,
wherein the place and the service to be presented change in association with each other.

20. An information processing apparatus comprising:
processing means for presenting a place that is a candidate for reservation and a service that is a candidate for use using a same application,
wherein the place and the service to be presented change in association with each other.
